(19) United States
(12) Patent Application Publication
(10) Pub. No.: US 2009/0180501 A1
(43) Pub. Date: Jul. 16, 2009

(54) LASER TUNING

(75) Inventors: Richard Jonathon Barlow, Northampton (GB); Giacinto Busico, Northampton (GB); Lee Nelson, Devon (GB); Michael Rigby-Jones, Devon (GB)

Correspondence Address: SUGHRUE MION, PLLC, 2100 PENNSYLVANIA AVENUE, N.W., SUITE 800, WASHINGTON, DC, 20037, US

(73) Assignee: Bookham Technology PLC, Northamptonshire (GB)

(21) Appl. No.: 12/158,905

(22) PCT Filed: Dec. 19, 2006
(86) PCT No.: PCT/GB2006/004788

§ 371 Date: Nov. 17, 2008

(30) Foreign Application Priority Data
Dec. 22, 2005 (GB) 0526187.0

(51) Int. Cl. H01S 3/13; H01S 3/04

(52) U.S. Cl. 372/32; 372/34

(57) ABSTRACT

A method of controlling a laser is provided for generating an optical output. The method includes the step of making a change to an electrical input to the laser so as to move the optical output of the laser towards a target frequency, and also includes the step of changing the temperature of the laser in relation to the change in the electrical input or the movement of the optical output. The method further includes the step of making further changes to the electrical input as the temperature of the laser is changed so as to maintain the optical output of the laser at the target frequency.

This invention relates to a laser tuning technique, particularly but not exclusively to a technique for tuning distributed Bragg reflector (DBR) lasers.

Semiconductor lasers are optoelectronic devices that are widely used for optical communication systems. Wavelength division multiplexed (WDM) and dense WDM (DWDM) optoelectronic devices have narrow specifications for their operating frequencies, and generally require feedback loops to maintain them at a constant frequency. Two types of semiconductor laser are commonly used in transmitter modules for WDM (and DWDM) applications. These are distributed feedback (DFB) lasers and distributed Bragg reflector (DBR) lasers.

Lasers may be used in either a continuous wave (CW) mode of operation, with a data signal being separately encoded onto the light by a modulator, or they can be driven directly with the data signal. Commonly, DFBs are used for direct modulation (i.e. as a direct modulation laser, DML), and DBR lasers are used in CW mode.

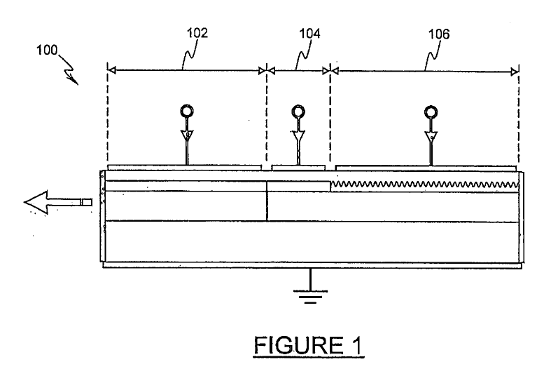

A typical DBR laser is shown in FIG. 1. The laser 100 in FIG. 1 has a plurality of separate sections typically comprising a gain section 102, a phase tuning section 104 and at least one DBR grating section 106. In typical DBR lasers the gain and frequency selection functions are substantially independent, and this generally enables them to operate over a wider tuning range than DFBs. Simple DBR lasers may have three sections, with the laser's optical cavity being defined between one DBR and a partially reflective facet. Typically three-section DBR lasers have an operating range of around 10 nm. DBR lasers in which the optical cavity is defined between two DBRs, typically have a much wider tuning range (e.g. >40nm). In a DBR laser with two DBRs a peak from each DBR is aligned in wavelength to provide a reinforced peak at which the cavity is above the lasing threshold.

In a DBR laser, light, in the form of an optical mode, travels along a waveguide within the laser, and partially overlaps with a grating. Both the pitch of the grating, and the effective refractive index experienced by the optical mode determine the operating frequency of the laser. The effective refractive index is a function of the material composition of the waveguide, the temperature of the laser and electrically induced optical effects (such as the carrier density within, or the bias applied across, the waveguide).

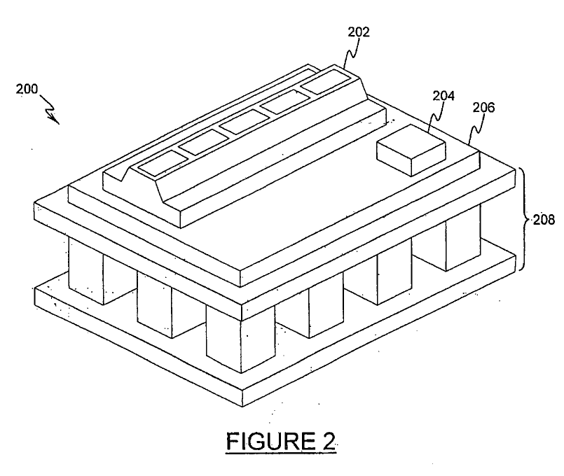

As described below, the temperature of the laser is typically controlled during the operation of the laser for data transmission. The laser is therefore commonly mounted on a thermoelectric cooler (TEC), e.g. a Peltier cooler. This is illustrated in FIG. 2, which shows a semiconductor chip 202, comprising a monolithically integrated four section laser and a semiconductor optical amplifier (SOA), together with a thermistor 204, which is used as a temperature sensor, mounted on a highly thermally conductive ceramic tile 206, which in turn is mounted on a TEC 208.

Within an optical cavity (such as within a DBR laser) the only permitted optical modes are those for which the optical cavity length corresponds to a whole number of half-wavelengths, thus for any cavity there is a comb of possible lasing frequencies, called longitudinal modes. The frequency at which the optical cavity lases is determined broadly by a reflective peak of the DBR(s), and more finely by the exact optical length of the cavity, which can be fine tuned by tuning the optical path length of the phase section. Both the grating and phase sections are tuned by means of varying their refractive indices by changing their electrical drive signals.

Known techniques for wavelength-tuning DBR lasers are (a) adjusting the reflection spectrum whilst independently maintaining the laser at a constant temperature; and (b) adjusting the temperature of the laser without electrically tuning the DBR (e.g. a DBR laser that does not have a drive signal applied to the DBR section).

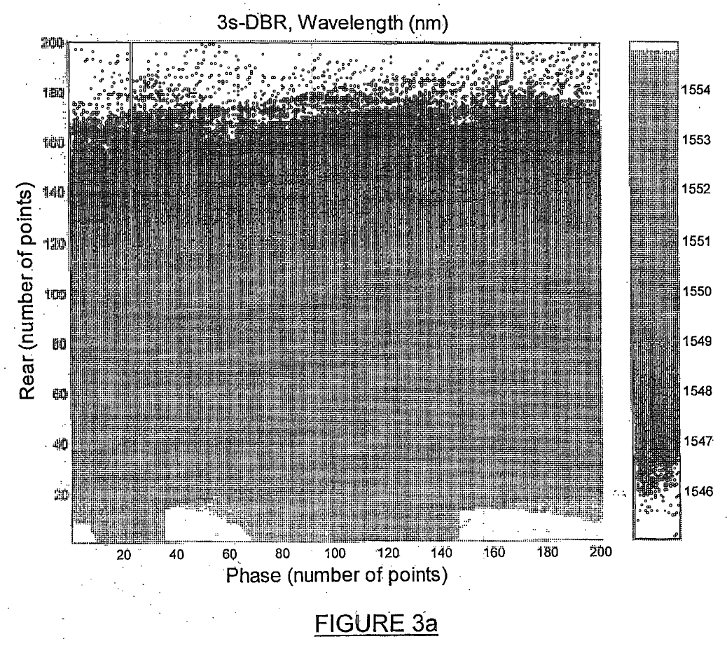

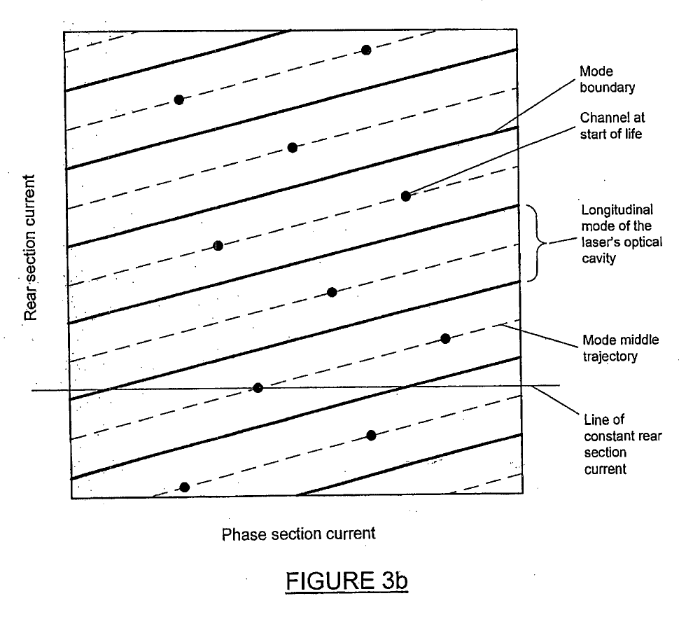

FIG. 3a shows a map of the free-space wavelength of the principal lasing mode of a three section DBR laser (similar to the DBR laser 100 in FIG. 1) as a function of the DBR section (also known as “rear section”) and phase section tuning currents. The map is divided into a pattern of stripes, each of which corresponds to one lasing mode of the cavity. As can be seen in FIG. 3a, the lasing wavelength varies across both the length (i.e. from right to left within each mode) and width of the modes, and down the page from one mode to the next. DBR lasers with a plurality of DBRs also have maps including a plurality of modes, in each of which the output free-space wavelengths is dependent on the electrical inputs, although the modes may have different shapes and sizes compared to the map shown in FIG. 3a.

FIG. 3b shows a schematic illustration of the lasing modes, their boundaries, and the positions at which the operating channels are chosen, away from the mode boundaries, and is referred to as the calibration map. The frequencies of the operating channels are normally those referred to as the ITU (International Telecommunication Union) grid.

For the purposes of FIG. 3b the mode boundaries have been shown as simple lines. However, a DBR laser typically experiences hysteresis in tuning: the position of the mode boundaries is dependant on the direction in which the laser is tuned (i.e. FIG. 3a shows the map of wavelength of the principal mode for one tuning direction). Due to the potential uncertainty of the lasing frequency, it is typically undesirable to operate the laser within a region of hysteresis, and thus the usable proportion of the mode is less than illustrated in FIG. 3b.

Several factors affect the performance of the laser, especially ageing and thermo-mechanical stress (stress brought about through changes in temperature of the chip and packaging). These factors result in a change in the output wavelength of the laser, and can also result in drifting of the laser modes with respect to the DBR (or rear) and phase section currents on the calibration map (shown in FIGS. 3a and 3b). A further effect of ageing is that the amount by which a laser tuning section tunes for a given change in drive current, which is known as tuning efficiency, typically decreases with age, which also results in a change in the positions of the mode boundaries on the calibration map.

In the initial calibration of the laser the locations of the channels within the calibration map are chosen to optimise the range over which the frequency locker (in co-operation with the control electronics) can safely re-tune the frequency through adjustment of the phase section current without reaching a mode boundary. However, a consequence of the performance effects above is that a danger arises that the operating positions of the channels can become close to mode boundaries creating the risk of “mode-hopping”. In particular, due to drifting of the modes on the calibration map a channel can move to the edge of a mode, and then when feedback from the frequency locker system is used to correct for further wavelength drift, by adjusting the phase section current, it is possible that the laser could mode-hop over a boundary into the next mode. Sudden jumps from one mode to the next produce undesirable jumps in the lasing frequency, which create unacceptable interruptions in the transmitted signal.

This can be particularly detrimental in telecommunications applications, where tuneable lasers, such as that shown in FIG. 1, are used as components inside optical transmitter modules. Such applications typically involve simultaneous transmission of many signals, at different frequencies, along each optical fibre, and require extremely high reliability of the received data when decoded (typically error rates are less than 1 in 10¹¹ in data that has been recovered using error correction bits). The data connection would be broken in the event that the operation of the laser should move across the boundary into another mode, and cease to be locked to the frequency of the channel. Also, subject to the relative size of the channel and mode spacings, a mode-hop could potentially result in the laser hopping onto or close to an adjacent channel and creating further problems.

A further issue is the effect that changes to the mode map have on channel switching. Typically the locations of the channels, on the calibration map, are determined at the beginning of life of the laser during calibration, and are stored in a look-up table. If the principal lasing frequency at a location has changed, then when a channel switch occurs to that location, then the laser feedback mechanism will have to retune the laser to a different location at which the lasing frequency is correct. For large changes to the mode map the channel switch may not just miss the channel, but may miss the correct mode altogether.

There is also a further consideration besides just the operating frequency, which is the spectral purity of the emitted light. In the output beam, although the emitted light is most intense at the principal lasing mode (the lasing frequency), there will also be less intense, undesirable, excited side modes. Subject to exactly how the fine comb of modes of the cavity is aligned with the principal reflective peak created by the DBR(s), the ratio of intensities of the principal mode and the largest side mode may vary greatly. This property is commonly measured and is referred to as the “side mode suppression ratio” (SMSR). When the principal longitudinal mode is aligned with the maximum of the DBR reflective peak, the SMSR will be greatest and this is the optimum operating condition for that frequency. With increasing misalignment the SMSR decreases, and since the reflective peak of the DBR (primarily controlled by the DBR drive current) and the comb of permitted longitudinal modes (typically primarily controlled by the phase section drive current) are to an extent independent, it will be appreciated that this can even occur whilst the frequency is kept constant. With even greater misalignment it is possible to reach a condition at which a neighbouring mode becomes the principal mode, and the laser experiences a “mode hop”, with a consequent change in lasing frequency, as discussed above.

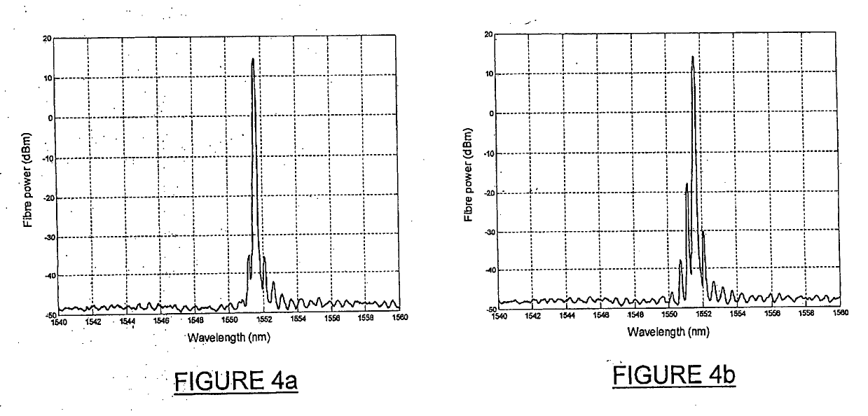

The variation of the SMSR value within a mode, when lasing at the same principal lasing frequency, is illustrated in FIGS. 4a and 4b. FIG. 4a shows the spectral profile of the laser output at a position close to the centre of a mode, at which point the side modes are small (i.e. large SMSR). FIG. 4b shows a comparable spectral profile measured closer to a mode boundary and shows a much larger side mode (i.e. smaller SMSR). In telecommunications applications, the data reception can be jeopardised by the laser operating close to a mode-hop boundary where the side modes become larger, as this can result in degradation in the clarity of the received optical signal, as well as possible cross-talk/adjacent channel interference. It is noted that the SMSR is typically not symmetric across the width of the mode, and in such a case the calibrated channel locations would normally be chosen to balance the concerns over being too close to a mode boundary and the concern that the SMSR should remain above performance limits over life, which may result in the selection of a calibrated channel location lying off the centre of the mode at a location of non-maximal SMSR.

GB2412230 describes a technique for tuning a DBR laser by adjusting the DBR grating section current and the phase section current whilst independently maintaining the temperature of the laser, so as to achieve the desired frequency at a position within a laser mode at which the SMSR is maximised. One technique involves making in situ measurements of the SMSR and adjusting the grating and phase section currents such that the SMSR is maximised for the desired frequency. This technique is presently considered to be relatively demanding in terms of expense, complexity and footprint size.

It is an aim of the present invention to provide an alternative technique for controlling an optic device so as to achieve the desired frequency at a desirable location within a laser mode.

According to one aspect of the present invention, there is provided a method of controlling a laser for generating an optical output including the step of making a change to an electrical input to the laser so as to move the optical output of the laser towards a target frequency, and also including the step of changing the temperature of the laser in relation to the change in said electrical input or the movement of the optical output, and further including the step of making further changes to said electrical input as the temperature of the laser is changed so as to maintain the optical output of the laser at said target frequency.

One embodiment of such method includes the steps of monitoring a deviation of the optical output of the laser away from a target frequency, making a change to an electrical input to the laser so as to correct the deviation away from the target frequency, and also including the step of changing the temperature of the laser in relation to the deviation of the optical output away from the target frequency.

According to another aspect of the present invention, there is provided a method of controlling a laser for generating an optical output, including the step of: changing an electrical input to the laser away from an initial value so as to maintain the frequency of the laser at a target frequency; and also including the step of: changing the temperature of the laser so as to change the relationship between said electrical input and the frequency of the optical output such that further changing of said electrical input so as to maintain the frequency of the optical output at a target frequency tends to maintain said electrical input at said initial value.

In one embodiment of such method, the step of changing the temperature of the laser includes monitoring an indicator of an actual value of said electrical input and comparing it against said initial value.

In another embodiment of such method, the temperature of the laser is carried out in response to a change in said electrical input according to a pre-calibrated relationship.

According to another aspect of the present invention, there is provided a controller for controlling a laser for generating an optical output, wherein said controller is arranged to make a change to an electrical input to the laser so as to move the optical output of the laser towards a target frequency, and wherein the controller is arranged to also change the temperature of the laser in relation to the change in said electrical input or the movement of the optical output, and wherein the controller is arranged to make further changes to said electrical input as the temperature of the laser is changed so as to maintain the optical output of the laser at said target frequency.

In one embodiment of such controller, the controller is arranged to monitor a deviation of the optical output of the laser away from a target frequency, and make a change to an electrical input to the laser so as to correct the deviation away from the target frequency, and wherein the controller is also arranged to change the temperature of the laser in relation to the deviation of the optical output away from the target frequency.

According to another aspect of the present invention, there is provided a controller for controlling a laser for generating an optical output, wherein said controller is arranged to change an electrical input to the laser away from an initial value so as to maintain the frequency of the optical output at a target frequency, and wherein said controller is also arranged to change the temperature of the laser so as to change the relationship between said electrical input and the frequency of the optical output such that a further change of said electrical input so as to maintain the frequency of the optical output at the target frequency tends to maintain said electrical input at the initial value.

According to another aspect of the present invention, there is provided an optic system including a laser for generating an optical output and a controller as described above for controlling said laser.

According to another aspect of the present invention, there is provided a computer program product comprising program code means which when loaded into a computer controls the computer to carry out the method as described above.

According to another aspect of the present invention, there is provided a laser device for generating an optical output, wherein an electrical input to the laser is changed so as to move the optical output of the laser towards a target frequency, and wherein the temperature of the laser device is changed in relation to the change in said electrical input or the movement of the optical output, and wherein said electrical input to the laser is further changed as the temperature of the laser is changed so as to maintain the optical output at the target frequency.

According to another aspect of the present invention, there is provided a laser device for generating an optical output, wherein an electrical input to the laser device is changed away from an initial value so as to maintain the frequency of the optical output at a target frequency, and wherein the temperature of the laser is changed so as to change the relationship between said electrical input and the frequency of the optical output such that a further change of said electrical input so as to maintain the frequency of the optical output at the target frequency tends to maintain said electrical input at the initial value.

In one embodiment, said electrical input is to a phase section of the laser. In another embodiment, said electrical input is to a DBR section of the laser.

For a better understanding of the present invention and to show how the same may be put into effect, reference will now be made, by way of example, to the following drawings in which:

FIG. 1 shows a typical distributed Bragg reflector laser;

FIG. 2 shows a DBR laser and thermistor mounted on a thermoelectric cooler;

FIG. 3a shows a calibration map of a typical three section DBR laser;

FIG. 3b shows a schematic illustration of lasing mode, mode boundaries and operating channels;

FIG. 4a shows a spectral profile of the output of a laser at an operating position close to the centre of a mode;

FIG. 4b shows a spectral profile of the output of a laser at an operating position close to a mode boundary;

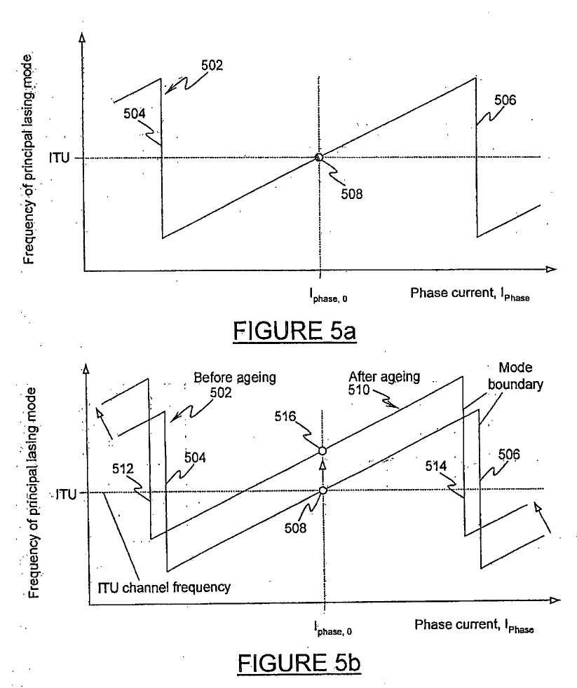

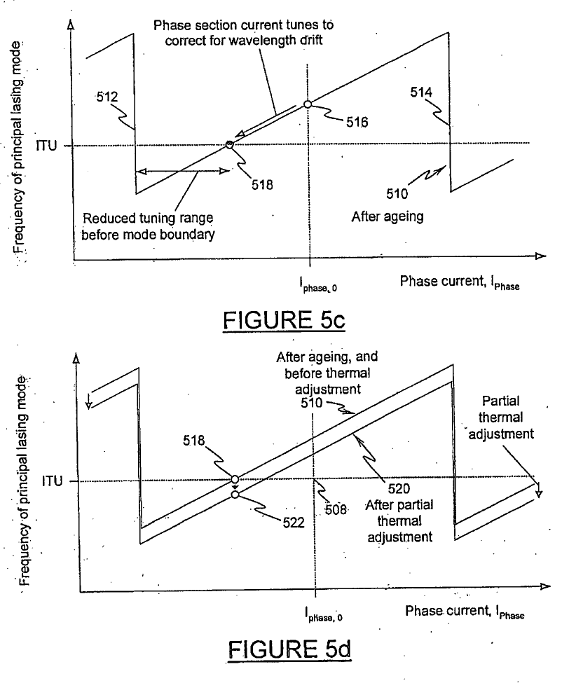

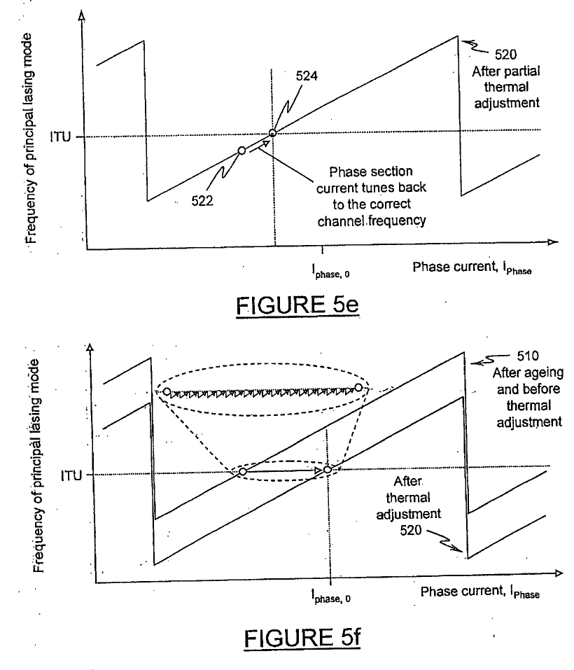

FIGS. 5a to 5g illustrate a method according to an embodiment of the present invention.

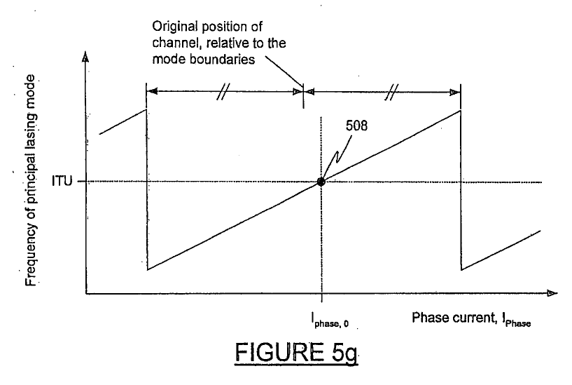

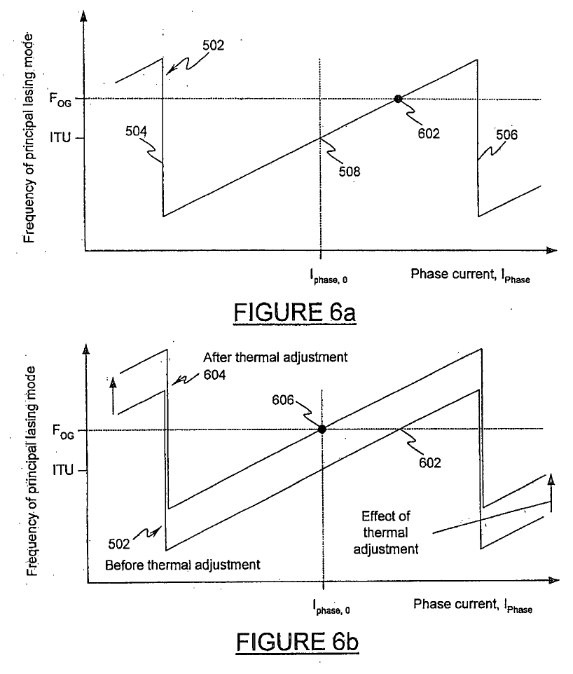

FIGS. 6a to 6b illustrate a method according to another embodiment of the present invention; and

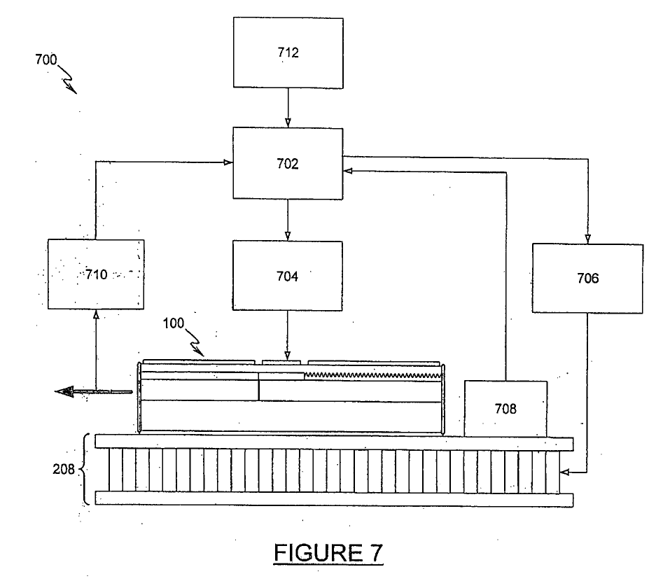

FIG. 7 shows an example of a control system for implementing the technique of the present invention.

According to a first embodiment of the invention, the operating temperature of a DBR laser is adjusted by a small amount to complement electrical tuning of the principal lasing frequency (hereafter referred to in the description of the embodiments as frequency or operating frequency) of the laser, in order to enable tuning along a trajectory “within the mode” that incurs higher SMSR and provides an increased tuning range before a mode-boundary is reached, compared with the conventional technique of tuning frequency solely by adjusting the phase section drive current (or voltage) whilst maintaining the laser at a constant temperature. The temperature of the whole chip is thus adjusted by controlling a current (i.e. the TEC drive current) separate to the electrical drive currents to the chip, and may thus remain of a design that is able to perform electrical tuning rapidly.

FIG. 5a shows an example of the variation in lasing frequency as a function of phase section current (I_{Phase}) 502, as the laser is tuned between two mode boundaries 504, 506 (i.e. at constant DBR current). This corresponds to a portion of the line of constant rear section current shown in the schematic calibration map in FIG. 3b. As marked by the point 508, the laser in FIG. 5a is producing an output wavelength at the ITU channel frequency (denoted “ITU”) for a phase section current I_{Phase, 0}.

FIG. 5b shows an example of the way that the frequency response of the laser can change due to effects such as ageing or thermo-mechanical stress. FIG. 5b shows the variation in lasing frequency as a function of phase section current before ageing 502, and after ageing 510. Generally, changes in the lasing frequency due to ageing and thermo-mechanical stress are accompanied by changes in the positions of the mode boundaries, and hence mode boundaries after ageing 512, 514 generally have different locations to those before ageing 504, 506. Typically such movement of the mode boundaries, with respect to phase and rear currents, is generally small. For a fixed phase section current, the change in the frequency response of the laser due to effects such as ageing or thermo-mechanical stress results in a change in the lasing frequency, as shown by point 516. The frequency of the laser for phase current I_{Phase, 0} is no longer at the ITU channel frequency.

As illustrated in FIG. 5c, the frequency locker detects the change in frequency and acts to tune the lasing frequency rapidly back to the correct channel frequency, by means of the phase section current. However this results in a new operating position 518 that is closer to one or other of the boundaries 512, 514 of the mode, so there is a reduced remaining tuning budget and typically reduced SMSR.

In the present embodiment, a further aspect of the feedback loop involves monitoring changes in the phase-section current and adjusting the operating temperature of the laser chip correspondingly, by means of the TEC drive current. This process is explained with reference to FIGS. 5d to 5g. FIG. 5d shows a change in the phase section current/frequency profile of the laser mode from that before thermal adjustment 510 to that after a partial thermal adjustment 520, which acts to detune the laser away from the target frequency.

Thermal adjustment is slow compared with phase current adjustment, and as the temperature is adjusted the frequency locker and control electronics are able to continuously track the effect to keep the lasing frequency at the frequency of the operating channel, by means of the phase section current. This is shown in FIG. 5e, where the phase section current tunes the laser from 522 to the correct ITU frequency at 524. The extent of the thermal adjustment shown in FIGS. 5d and 5e is exaggerated for clarity. Since the phase current adjustment is very rapid in comparison to the thermal adjustment, the frequency does not deviate significantly from the ITU frequency as the thermal adjustment is performed. The process in FIGS. 5d and 5e is repeated until the phase current is returned to the original phase current, I_{Phase, 0}. This is illustrated in FIG. 5f, which shows the thermal adjustment returning the phase section current to I_{Phase, 0}, and the phase section current continuously ensuring that the lasing frequency remains at the ITU frequency.

FIG. 5g shows the situation after completion of the thermal adjustment, such that point 508 is at the ITU channel frequency for I_{Phase, 0}. This operating scheme is simple to implement, and uses a feedback loop to monitor deviations in the phase current and make corresponding changes to the temperature of the laser so as to maintain the phase section current at the original value.

Although the laser is not necessarily back operating at the centre of the mode, any deviation from the centre of the mode is less than would be the case with the conventional technique of tuning frequency by adjusting phase section current whilst maintaining the temperature of the laser constant (as can be seen by comparing FIG. 5e below with FIG. 5c) and so provides an enhanced tuning range, increased reliability of channel switching and improved SMSR, and can extend the useable life of the laser. This tuning scheme is particularly suitable for use in systems where the through-life changes predominantly entail changes in the phase section current/frequency profile of the laser modes without any more significant change in the positions of the mode boundaries.

It should be appreciated that FIGS. 5a-5g are merely illustrative and have been exaggerated for the sake of clarity. In the system according to the present embodiment the system continuously monitors changes and typically the excursions and corrections shown in the illustrations above are very small (ideally they would be infinitesimal). This is in contrast to the conventional techniques of tuning frequency by adjusting the phase section current whilst maintaining the temperature of the laser constant, where the changes to the phase section current may be relatively large.

A second embodiment of the invention involves the use of combined thermal and phase section adjustments to enable “off-grid” operation of a laser, whilst still preserving a useful tuning range (“tuning budget”) to correct for future ageing and thermo-mechanical stresses. Some users of a laser want to be able to operate lasers over a range of several GHz about each of the channels of the ITU grid.

It can be very time consuming to fully calibrate the laser at a large number of possible operating frequencies around each ITU channel with respect to all possible drive currents. Instead it can be preferable to calibrate to the corresponding ITU channel, and then to tune out across the off-grid operating range as an excursion from that ITU channel. However, with the conventional technique of tuning frequency by adjusting the phase section current whilst maintaining the temperature of the laser constant, this would result in an operating point at the ends of the off-grid operating range being much closer to a mode boundary than the corresponding ITU channel, as is illustrated in FIG. 6a, leaving a smaller tuning range available to compensate for ageing and resulting in the device typically operating in a region of lower SMSR (i.e. larger side modes). FIG. 6a shows a response similar to that described previously with reference to FIG. 5a, except that the laser is being tuned with a phase current that is different to I_{Phase, 0} in order to operate at an off-grid frequency (“F_{OG}”), as shown at point 602.

In this second embodiment of the invention, phase section current adjustments are used with corresponding thermal adjustments to provide a simple means to operate the laser at frequencies that are away from ITU grid channels whilst keeping the operating point away from the mode boundaries, and thus substantially preserve the local tuning range. This is shown illustrated in FIG. 6b, where the phase section current/frequency profile after thermal adjustment 604 allows the laser to operate at the off-grid frequency, F_{OG}, with the phase section current back at the same level as for the corresponding ITU grid channel, I_{Phase, 0}. In other words, point 606 is back in the centre of the mode. In this embodiment, the gradient of the frequency profile is calibrated at the start of life, and then the temperature is adjusted in correspondence with the required excursion in frequency.

When the control electronics is reconfigured to switch the output to the off-grid frequency, then initially the laser frequency can rapidly be tuned to the off-grid frequency by adjusting the phase section current. More slowly, thermal adjustment can be achieved by control of the TEC, during which thermal adjustment the phase section current correspondingly tracks to keep the output wavelength at the chosen off-grid operating frequency, until the phase section current is back to the original level, I_{Phase, 0} (i.e. the same as that of the corresponding ITU grid channel) at which the operating point is again safely away from the mode boundaries.

Reference is now made to FIG. 7, which illustrates, schematically, a control system 700 for implementing the two embodiments described hereinbefore. The control electronics 702 receives an input indicating the desired operating frequency 712, and controls the drive signals from a phase section current source 704 and a TEC driver 706. The thermistor 708 and frequency locker 710 monitor the TEC 208 temperature and the output frequency, respectively, and provide feedback to the control electronics 702 to enable the control electronics to maintain the output of the laser 100 at the desired operating frequency 712 and at the desired operating position within the respective laser mode. The temperature of the TEC 208 that is monitored by the thermistor 708 and provided to the control electronics is correlated to the temperature of the laser 100. The control electronics controls the current provided by the phase section current source 704 to the laser 100 through electrical signals. The knowledge of the electrical signals controlling the phase section current source 704 is also utilised by the control electronics 702 to determine when the thermal adjustment has returned the phase section current to I_{Phase, 0}. Other electrical components that will be familiar to one skilled in the art have been omitted from FIG. 7 for the sake of clarity.

The control electronics 702 may comprise hardware or could be provided through software. The phase section current source 704 may comprise two current sources, e.g. a first current source that provides a fixed current determined during calibration at the beginning of life, and a second current source that provides tuning of the phase section.

The applicant draws attention to the fact that the present invention may include any feature or combination of features disclosed herein either implicitly or explicitly or any generalisation thereof, without limitation to the scope of any definitions set out above. In view of the foregoing description it will be evident to a person skilled in the art that various modifications may be made within the scope of the invention.

For example, the two embodiments described above by way of example involve adjusting the phase section current and making corresponding thermal adjustments. However, in an alternative example, the electrical input to other sections of the laser, such as a DBR (or rear) section, could be adjusted (with or without adjustments to the phase section current).

Also, in an alternative example of an operating scheme, as the phase current is changed by the locker, the temperature may also be changed by a corresponding amount, by means of a dead-reckoning approach. In such a dead-reckoning approach, in response to a deviation of the operating frequency of the laser: firstly the phase section current is adjusted to maintain the operating frequency of the laser in response to a signal from the frequency locker; and secondly the temperature is adjusted in accordance with pre-calibrated relationship and the extent of the deviation in frequency As before, as the temperature is adjusted, the phase section current is adjusted in response to a signal from the frequency locker to maintain the operating frequency of the laser. The pre-calibrated relationship may, for example, be that between the temperature adjustment and either the frequency deviation or the phase current adjustment. The pre-calibrated relationship may be calibrated at the beginning of life, and it is assumed that it does not substantially change throughout life.

In a further example of an operating scheme the pre-calibrated relationship may include a further parameter that accounts fully or partially for the average ageing behaviour of a laser.

With the above-described techniques, the mode map can be readjusted to position the operating channels closer to desired positions within the modes (such as, for example, the centres of the modes), thereby reducing the likelihood of a mode-hop occurring due to ageing and thermo-mechanical stress, increasing the likelihood of a channel switch being made into the correct mode, and increasing SMSR.

1. A method of controlling a laser for generating an optical output including the step of making a change to an electrical input to the laser so as to move the optical output of the laser towards a target frequency, and also including the step of changing the temperature of the laser in relation to the change in said electrical input or the movement of the optical output, and further including the step of making further changes to said electrical input as the temperature of the laser is changed so as to maintain the optical output of the laser at said target frequency.

2. A method according to claim 1, including the steps of monitoring a deviation of the optical output of the laser away from a target frequency, making a change to an electrical input to the laser so as to correct the deviation away from the target frequency, and also including the step of changing the temperature of the laser in relation to the deviation of the optical output away from the target frequency.

3. A method of controlling a laser for generating an optical output, including the step of: changing an electrical input to the laser away from an initial value so as to maintain the frequency of the laser at a target frequency; and also including the step of: changing the temperature of the laser so as to change the relationship between said electrical input and the frequency of the optical output such that further changing of said electrical input so as to maintain the frequency of the optical output at a target frequency tends to maintain said electrical input at said initial value.

4. A method according to claim 3, wherein the step of changing the temperature of the laser includes monitoring an indicator of an actual value of said electrical input and comparing it against said initial value.

5. A method according to claim 3, wherein changing the temperature of the laser is carried out in response to a change in said electrical input according to a pre-calibrated relationship.

6. A controller for controlling a laser for generating an optical output, wherein said controller is arranged to make a change to an electrical input to the laser so as to move the optical output of the laser towards a target frequency, and wherein the controller is arranged to also change the temperature of the laser in relation to the change in said electrical input or the movement of the optical output, and wherein the controller is arranged to make further changes to said electrical input as the temperature of the laser is changed so as to maintain the optical output of the laser at said target frequency.

7. A controller according to claim 6, wherein the controller is arranged to monitor a deviation of the optical output of the laser away from a target frequency, and make a change to an electrical input to the laser so as to correct the deviation away from the target frequency, and wherein the controller is also arranged to change the temperature of the laser in relation to the deviation of the optical output away from the target frequency.

8. A controller for controlling a laser for generating an optical output, wherein said controller is arranged to change an electrical input to the laser away from an initial value so as to maintain the frequency of the optical output at a target frequency, and wherein said controller is also arranged to change the temperature of the laser so as to change the relationship between said electrical input and the frequency of the optical output such that a further change of said electrical input so as to maintain the frequency of the optical output at the target frequency tends to maintain said electrical input at the initial value.

9. An optic system including a laser for generating an optical output and a controller according to claim 6 for controlling said laser.

10. A computer program product comprising program code means which when loaded into a computer controls the computer to carry out the method of claim 1.

11. A laser device for generating an optical output, wherein an electrical input to the laser is changed so as to move the optical output of the laser towards a target frequency, and wherein the temperature of the laser device is changed in relation to the change in said electrical input or the movement of the optical output, and wherein said electrical input to the laser is further changed as the temperature of the laser is changed so as to maintain the optical output at the target frequency.

12. A laser device for generating an optical output, wherein an electrical input to the laser device is changed away from an initial value so as to maintain the frequency of the optical output at a target frequency, and wherein the temperature of the laser is changed so as to change the relationship between said electrical input and the frequency of the optical output such that a further change of said electrical input so as to maintain the frequency of the optical output at the target frequency tends to maintain said electrical input at the initial value.

13. An optic system including a laser for generating an optical output and a controller according to claim 7 for controlling said laser.

14. A computer program product comprising program code means which when loaded into a computer controls the computer to carry out the method of claim 2.

15. An optic system including a laser for generating an optical output and a controller according to claim 8 for controlling said laser.

16. A computer program product comprising program code means which when loaded into a computer controls the computer to carry out the method of claim 3.
